(19) United States
(12) Patent Application Publication
(10) Pub. No.: US 2009/0271847 A1
(43) Pub. Date: Oct. 29, 2009

(54) Methods, Apparatuses, and Computer Program Products for Providing a Single Service Sign-On

(75) Inventors: Jari Karjala, Vantaa (FI); Ari Vepsalainen, Espoo (FI); Jussi Maki, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/109,644

(22) Filed: Apr. 25, 2008

(51) Int. Cl. H04L 9/32

(52) U.S. Cl. 726/6

(57) ABSTRACT

An apparatus may include a processor configured to receive a request for an access token from a remote entity, wherein the request includes an indication of a requested service. The processor may be further configured to determine a request type, wherein the request type may be a user identification and password combination, a request token exchange, or an access token exchange. The processor may be additionally configured to extract one or more parameters included in the request based upon the determined request type and to perform one or more security checks based at least in part upon the one or more extracted parameters. The processor may be further configured to create an access token based at least in part upon the results of the one or more security checks and to provide the access token to the remote entity.

### TECHNOLOGICAL FIELD

Embodiments of the present invention relate generally to mobile communication technology and, more particularly, relate to methods, apparatuses, and computer program products for providing a single service sign-on for web and mobile device users.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to further improve the ease of information transfer and convenience to users involves the authentication of users accessing services over a network. Some of these services have been commonly available for users of personal computers and other computing devices for some time, but recently have become available to mobile terminal users due to the growth in wireless and mobile networking technologies as well as continued development of processing power and miniaturization of high-powered processors and components used in mobile computing devices. Examples of these services include e-mail, instant messaging, multi-player gaming, peer-to-peer file transfer, web browsing, social networking, and photograph hosting.

These services may require users of mobile terminals and other computing devices to establish a user account and to authenticate to each service using a unique sign-on upon each use of a service. For example, a user may have to authenticate to a photo hosting service in order to manage the user's online photo albums. While using the photo hosting service, the user may wish to upload photographs to a storage service or otherwise access photographs stored in a storage service for use in conjunction with the photo hosting service. The storage service may require the user to separately sign onto the storage service prior to using the service. As such, users may experience frustration with having to remember multiple user names and passwords and to separately sign-on to each service upon each use thereof.

Although some existing services have attempted to solve this service sign-on problem such as by providing a single sign-on at an internet portal that provides access to a number of services for users accessing services via a web browser, existing single sign-on solutions fail to account for the fact that computing device users may access services over a variety of application user interfaces on a variety of computing devices using a variety of communication protocols. Some of these services may themselves access other services on behalf of a user during a user's service session.

In addition to benefits that may inure to users by providing a single service sign-on, service providers may also realize benefits in that authentication responsibility may be delegated to a single management entity through a common service authentication interface. Furthermore, such a common service authentication interface may allow for the use of common libraries in applications and services which may streamline service development and deployment costs as well as provide for enhanced security.

Accordingly, it may be advantageous to provide users with a system for providing a single sign-on that allows for the invocation of multiple services using multiple application interfaces implemented on multiple devices using multiple communication protocols. Such a system may thereby address at least some of the disadvantages described above.

### BRIEF SUMMARY

A method, apparatus, and computer program product are therefore provided to enable providing a single service sign-on to users of computing devices. In particular, a method, apparatus, and computer program product are provided to enable, for example, a user of a device to sign-on once and have access to multiple services with which he is registered or otherwise authorized to use without requiring the user to enter additional sign-on information to use other services. The provided single service sign-on is device and application independent as a account management provider may receive and respond to requests received in several different protocols.

In one exemplary embodiment, a method is provided which may include receiving a request for an access token from a remote entity, wherein the request includes an indication of a requested service. The method may further include determining a request type, wherein the request type may be a user identification and password combination, a request token exchange, or an access token exchange. The method may further include extracting one or more parameters included in the request based upon the determined request type and performing one or more security checks based at least in part upon the one or more extracted parameters. The method may additionally include creating an access token based at least in part upon results of the one or more security checks and providing the access token to the remote entity.

In another exemplary embodiment, a computer program product is provided. The computer program product includes at least one computer-readable storage medium having computer-readable program code portions stored therein. The computer-readable program code portions include first, second, third, fourth, fifth, and sixth program code portions. The first program code portion is for receiving a request for an access token from a remote entity, wherein the request includes an indication of a requested service. The second executable portion is for determining a request type, wherein the request type may be a user identification and password combination, a request token exchange, or an access token exchange. The third executable portion is for extracting one or more parameters included in the request based upon the determined request type. The fourth executable portion is for performing one or more security checks based at least in part upon the one or more extracted parameters. The fifth executable portion is for creating an access token based at least in part upon results of the one or more security checks. The sixth executable portion is for providing the access token to the remote entity.

In another exemplary embodiment, an apparatus is provided, which may include a processor. The processor may be configured to receive a request for an access token from a remote entity, wherein the request includes an indication of a requested service. The processor may be further configured to determine a request type, wherein the request type may be a user identification and password combination, a request token exchange, or an access token exchange. The processor may be additionally configured to extract one or more parameters included in the request based upon the determined request type and to perform one or more security checks based at least in part upon the one or more extracted parameters. The processor may be further configured to create an access token based at least in part upon the results of the one or more security checks and to provide the access token to the remote entity.

In another exemplary embodiment, an apparatus is provided. The apparatus may include means for receiving a request for an access token from a remote entity, wherein the request includes an indication of a requested service. The apparatus may further include means for determining a request type, wherein the request type may be a user identification and password combination, a request token exchange, or an access token exchange. The apparatus may additionally include means for extracting one or more parameters included in the request based upon the determined request type. The apparatus may further include means for performing one or more security checks based at least in part upon the one or more extracted parameters. The apparatus may additionally include means for creating an access token based at least in part upon results of the one or more security checks. The apparatus may further include means for providing the access token to the remote entity.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of a system for providing a single service sign-on according to an exemplary embodiment of the present invention;

FIG. 4 illustrates a block diagram of a system for providing a single service sign-on according to another exemplary embodiment of the present invention;

FIG. 5 is a flowchart according to an exemplary method for providing a single service sign-on according to an exemplary embodiment of the present invention; and

FIG. 6 is a flowchart according to an exemplary method for providing a single service sign-on according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

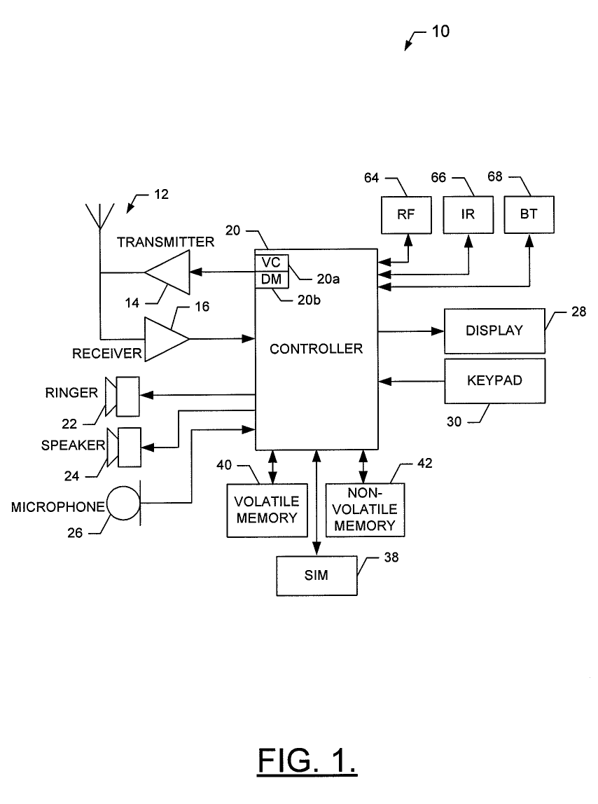

FIG. 1 illustrates a block diagram of a mobile terminal 10 that may benefit from the present invention. It should be understood, however, that the mobile terminal illustrated and hereinafter described is merely illustrative of one type of electronic device that may benefit from the present invention and, therefore, should not be taken to limit the scope of the present invention. While several embodiments of the electronic device are illustrated and will be hereinafter described for purposes of example, other types of electronic devices, such as portable digital assistants (PDAs), pagers, laptop computers, desktop computers, gaming devices, televisions, and other types of electronic systems, may employ the present invention.

As shown, the mobile terminal 10 may include an antenna 12 in communication with a transmitter 14 and a receiver 16. The mobile terminal may also include a controller 20 or other processor that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi), wireless LAN (WLAN) techniques such as IEEE 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (TDMA), GSM, and IS-95 (CDMA). Also, for example, the mobile terminal may be capable of operating in accordance with 2.5G wireless communication protocols GPRS, EDGE, or the like. Further, for example, the mobile terminal may be capable of operating in accordance with 3G wireless communication protocols such as UMTS, CDMA2000, WCDMA and TD-SCDMA. The mobile terminal may be additionally capable of operating in accordance with 3.9G wireless communication protocols such as LTE or E-UTRAN. Additionally, for example, the mobile terminal may be capable of operating in accordance with fourth-generation (4G) wireless communication protocols or the like as well as similar wireless communication protocols that may be developed in the future.

Some NAMPS, as well as TACS, mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) protocols.

It is understood that the controller 20 may comprise the circuitry required for implementing audio and logic functions of the mobile terminal 10. For example, the controller 20 may be a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a Web browser. The connectivity program may allow the mobile terminal 10 to transmit and receive Web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive Web content across Internet 50.

The mobile terminal 10 may also comprise a user interface including a conventional earphone or speaker 24, a ringer 22, a microphone 26, a display 28, a user input interface, and/or the like, which may be coupled to the controller 20. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise conventional numeric (0-9) and related keys (#, *), and/or other keys for operating the mobile terminal.

As shown in FIG. 1, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example an infrared (IR) transceiver 66, a Bluetooth™ (BT) transceiver 68 operating using Bluetooth™ brand wireless technology developed by the Bluetooth™ Special Interest Group, and/or the like. The Bluetooth transceiver 68 may be capable of operating according to Wibree™ radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. In this regard, the mobile terminal may comprise volatile memory 40, such as volatile Random Access Memory (RAM), which may comprise a cache area for temporary storage of data. The mobile terminal may comprise other non-volatile memory 42, which may be embedded and/or may be removable. The non-volatile memory may comprise an EEPROM, flash memory, and/or the like. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

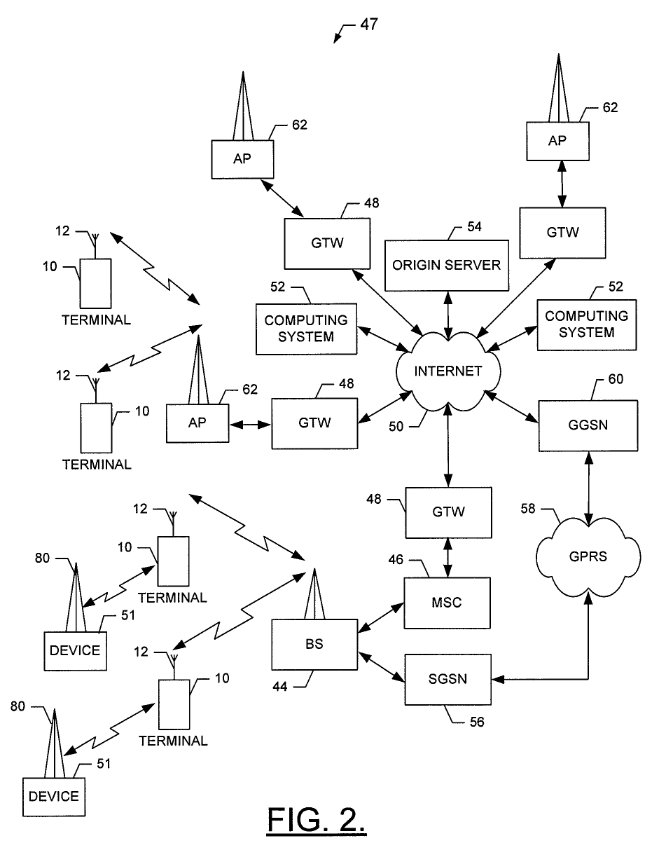

Referring now to FIG. 2, an illustration of one type of system that could support communications to and from an electronic device, such as the mobile terminal of FIG. 1, is provided by way of example, but not of limitation. As shown, one or more mobile terminals 10 may each include an antenna 12 for transmitting signals to and for receiving signals from a base site or base station (BS) 44. The base station 44 may be a part of one or more cellular or mobile networks each of which may comprise elements required to operate the network, such as a mobile switching center (MSC) 46. As well known to those skilled in the art, the mobile network may also be referred to as a Base Station/MSC/Interworking function (BMI). In operation, the MSC 46 may be capable of routing calls to and from the mobile terminal 10 when the mobile terminal 10 is making and receiving calls. The MSC 46 may also provide a connection to landline trunks when the mobile terminal 10 is involved in a call. In addition, the MSC 46 may be capable of controlling the forwarding of messages to and from the mobile terminal 10, and may also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 may be coupled to a data network, such as a local area network (LAN), a metropolitan area network (MAN), and/or a wide area network (WAN). The MSC 46 may be directly coupled to the data network. In one typical embodiment, however, the MSC 46 may be coupled to a GTW 48, and the GTW 48 may be coupled to a WAN, such as the Internet 50. In turn, devices such as processing elements (e.g., personal computers, server computers or the like) may be coupled to the mobile terminal 10 via the Internet 50. For example, as explained below, the processing elements may include one or more processing elements associated with a computing system 52 (two shown in FIG. 2), origin server 54 (one shown in FIG. 2) or the like, as described below.

As shown in FIG. 2, the BS 44 may also be coupled to a signaling GPRS (General Packet Radio Service) support node (SGSN) 56. As known to those skilled in the art, the SGSN 56 may be capable of performing functions similar to the MSC 46 for packet switched services. The SGSN 56, like the MSC 46, may be coupled to a data network, such as the Internet 50. The SGSN 56 may be directly coupled to the data network. Alternatively, the SGSN 56 may be coupled to a packet-switched core network, such as a GPRS core network 58. The packet-switched core network may then be coupled to another GTW 48, such as a GTW GPRS support node (GGSN) 60, and the GGSN 60 may be coupled to the Internet 50. In addition to the GGSN 60, the packet-switched core network may also be coupled to a GTW 48. Also, the GGSN 60 may be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown in FIG. 2 and described herein, it should be appreciated that electronic devices, such as the mobile terminal 10, may be coupled to one or more of any of a number of different networks through the BS 44. In this regard, the network(s) may be capable of supporting communication in accordance with any one or more of a number of first-generation (1G), second-generation (2G), 2.5G, third-generation (3G), fourth generation (4G) and/or future mobile communication protocols or the like. For example, one or more of the network(s) may be capable of supporting communication in accordance with 2G wireless communication protocols IS-136 (TDMA), GSM, and IS-95 (CDMA). Also, for example, one or more of the network(s) may be capable of supporting communication in accordance with 2.5G wireless communication protocols GPRS, Enhanced Data GSM Environment (EDGE), or the like. Further, for example, one or more of the network(s) may be capable of supporting communication in accordance with 3G wireless communication protocols such as E-UTRAN or a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile terminals (e.g., digital/analog or TDMA/CDMA/analog phones).

As depicted in FIG. 2, the mobile terminal 10 may further be coupled to one or more wireless access points (APs) 62. The APs 62 may comprise access points configured to communicate with the mobile terminal 10 in accordance with techniques such as, for example, radio frequency (RF), Bluetooth™ (BT), infrared (IrDA) or any of a number of different wireless networking techniques, including wireless LAN (WLAN) techniques such as IEEE 802.11 (e.g., 802.11a, 802.11b, 802.11g, 802.11n, etc.), Wibree™ techniques, WiMAX techniques such as IEEE 802.16, Wireless-Fidelity (Wi-Fi) techniques and/or ultra wideband (UWB) techniques such as IEEE 802.15 or the like. The APs 62 may be coupled to the Internet 50. Like with the MSC 46, the APs 62 may be directly coupled to the Internet 50. In one embodiment, however, the APs 62 may be indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 may communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 and/or origin server 54 across the Internet 50, the mobile terminal 10, computing system 52 and origin server 54 may be coupled to one another and communicate in accordance with, for example, RF, BT, IrDA or any of a number of different wireline or wireless communication techniques, including LAN, WLAN, WiMAX, Wireless Fidelity (Wi-Fi), Wibree™ and/or UWB techniques. One or more of the computing systems 52 may additionally, or alternatively, include a removable memory capable of storing content, which can thereafter be transferred to the mobile terminal 10. Further, the mobile terminal 10 may be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, Wibree™, Wi-Fi, WLAN, WiMAX and/or UWB techniques. In this regard, the mobile terminal 10 may be capable of communicating with other devices via short-range communication techniques. For instance, the mobile terminal 10 may be in wireless short-range communication with one or more devices 51 that are equipped with a short-range communication transceiver 80. The electronic devices 51 may comprise any of a number of different devices and transponders capable of transmitting and/or receiving data in accordance with any of a number of different short-range communication techniques including but not limited to Bluetooth™, RFID, IR, WLAN, Infrared Data Association (IrDA) or the like. The electronic device 51 may include any of a number of different mobile or stationary devices, including other mobile terminals, wireless accessories, appliances, portable digital assistants (PDAs), pagers, laptop computers, motion sensors, light switches and other types of electronic devices.

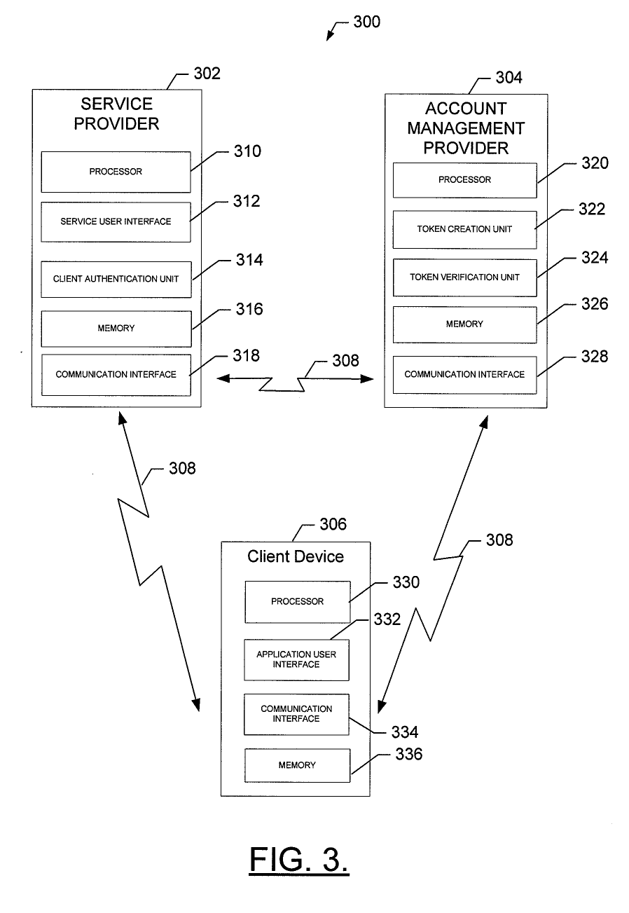

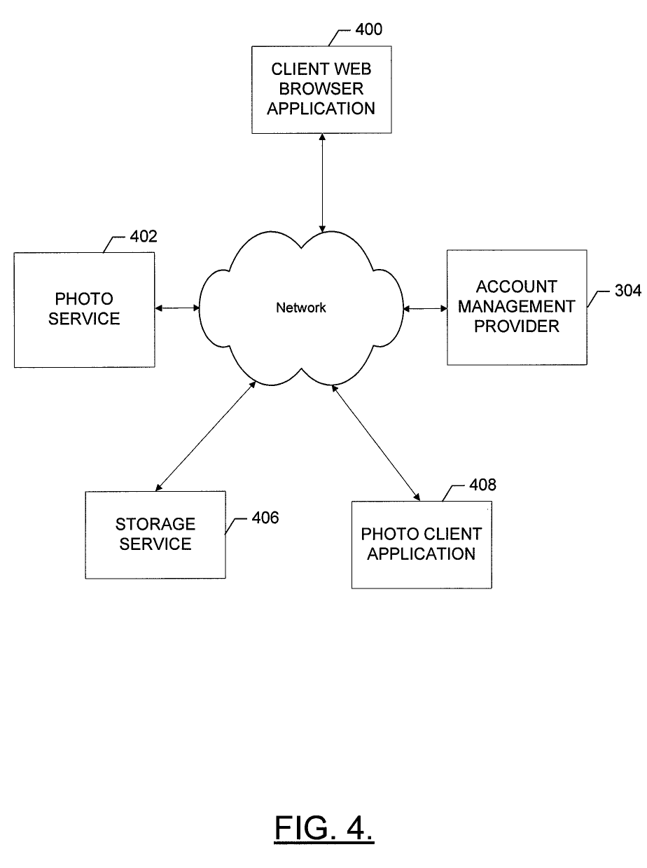

FIG. 3 illustrates a block diagram of a system 300 for providing a single service sign-on according to an exemplary embodiment of the invention. As used herein, “exemplary” merely means an example and as such represents one example embodiment for the invention and should not be construed to narrow the scope or spirit of the invention in anyway. It will be appreciated that the scope of the invention encompasses many potential embodiments in addition to those illustrated and described herein. The system 300 will be described, for purposes of example, in connection with the mobile terminal 10 of FIG. 1 and the system 47 of FIG. 2. However, it should be noted that the system of FIG. 3, may also be employed in connection with a variety of other devices, both mobile and fixed, and therefore, embodiments of the present invention should not be limited to application on devices such as the mobile terminal 10 of FIG. 1. Further, it should be noted that the system of FIG. 3 may be used in connection with any of a variety of network configurations or protocols and is not limited to embodiments using aspects of the system 47 of FIG. 2. It should also be noted, that while FIG. 3 illustrates one example of a configuration of a system for providing a single service sign-on, numerous other configurations may also be used to implement embodiments of the present invention.

Referring now to FIG. 3, the system 300 may include a service provider 302, an account management provider 304, and a client device 306. The service provider 302 and account management provider 304 may each be embodied as any computing device or combination of a plurality of computing devices. In this regard, the service provider 302 and account management provider 304 may each be embodied, for example, as a server or a server cluster. The entities of the system 300 may communicate with each other over the communication links 308. These communication links may be any computer network structure, such as that of the system 47 of FIG. 2 and may utilize any communications protocol or combination of communications protocols that may facilitate inter-device communication between the service provider 302, account management provider 304, and the client device 306. Additionally, although the system 300 only illustrates one service provider 302 and client device 306 for purposes of example, the system 300 may include a plurality of service providers 302 and client devices 306.

The service provider 302 may provide a service to remote users. As used herein, “service” may include data or other content as well as services, such as, for example, e-mail, instant messaging, multi-player gaming, peer-to-peer file transfer, web browsing, social networking, photograph hosting, video hosting, and other multimedia hosting services that may be accessed by and/or supplied to remote computing devices over a network or communications link such as the communications link 308. In this regard, a service provides some function to a user. In an exemplary embodiment, the service provider 302 may include a processor 310, service user interface 312, client authentication unit 314, memory 316, and communication interface 318.

The processor 310 may be embodied in a number of different ways. For example, the processor 310 may be embodied as a microprocessor, a coprocessor, a controller, or various other processing means or elements including integrated circuits such as, for example, an ASIC (application specific integrated circuit) or FPGA (field programmable gate array). In an exemplary embodiment, the processor 310 may be configured to execute instructions stored in the memory 316 or otherwise accessible to the processor 310.

The service user interface 312 may be in communication with the processor 310 to receive an indication of a user input or request received by the communication interface 318 and/or to provide an audible, visual, mechanical, or other output to the user via the communication interface 318. These outputs may facilitate users' usage of and interaction with a service provided by the service provider 302. Accordingly, the service user interface 312 may provide, for example, a web page, GUI, or other interaction means that may be communicated via the communication interface 318 to a user device, such as the client device 306 over a communication link 308. In this regard, the service user interface 312 may be configured to handle the provision of the service provided by the service provider 302 to authenticated users of client devices 306 as well as to other service providers which may be invoking the service provided by service provider 302.

The client authentication unit 314 may be embodied as hardware, software, firmware, or some combination thereof and may be embodied as or otherwise controlled by the processor 310. In embodiments where the client authentication unit 314 is embodied separately from the processor 310, the client authentication unit 314 may be in communication with the processor 310. The client authentication unit 310 may be configured to receive a service access request message from a client device 306 or from another service provider (collectively referred to as a “requesting client”). The client authentication unit 310 may further be configured to construct and send a service access request message to another service provider. In an exemplary embodiment, the client authentication unit 310 may be configured to determine a type of the requesting client as well as a type of client application used to make the request. The client authentication unit 314 may additionally be configured to determine whether there is an existing sign-on session for the requesting client and/or a user thereof, such as in the case where the requesting client or user has been authenticated by the client authentication unit 314 previously for a use session that has not expired.

A “service access request message” may be any message or other indication from any remote device indicating or requesting use of or access to a service provided by the service provider 302. In this regard, a service access request message may include one or more parameters. As used herein, “parameters” may include one-bit flag indicators, values or indicators comprised of a plurality of bits, as well as files or objects that may be appended to or included in the body of a message. In this regard, a parameter may be included in a message body, signature, or in a message header. A service access request message may include, for example, one or more of the following parameters: access token, request token, user identification, password, hash of a password, a client key, a client secret, token secret, service secret, and service key. In addition, one or more of these parameters may be used to sign the message. In some embodiments, parameters included in a service request message may comply with the OAuth protocol.

As used herein, the term “access token” refers to a tuple with information, which may be created by the account management provider 304 in a manner further described herein. In this regard, an “access token” may be associated with a particular user or consumer of the service and serve as an indication that the user has permission, such as based upon a determination by the account management provider 304, to access a service provided by the service provider 302. The access token may further indicate or otherwise be associated with information indicating an extent such as time or scope of a user's access rights. Accordingly, an access token may be limited in the time of use, scope of use, and/or number of uses of a service.

As used herein, the term “request token” refers to a tuple that binds a service to an authenticated user session. A request token may be provided to a service provider 302, such as in a service access request message. The client authentication unit 310 may then be configured to retrieve the request token from the message and provide it to the account management provider in exchange for an access token. “Secret” as used herein, refers to a secret such as a unique alphanumeric value, that is associated with a client, service, or token (i.e., “client secret,” “service secret,” or “token secret”). Although sometimes referred to separately as a “client key” and a “service key” for purposes of illustration, the terms are interchangeable and may be collectively referred to as a “client key”. Furthermore, although sometimes referred to separately as a “client secret” and a “service secret” for purposes of illustration, the terms are interchangeable and may be collectively referred to as a “client secret”.

The client authentication unit 310 may further be configured to retrieve or extract parameters from a service access request message, such as by parsing. In this regard, the client authentication unit may be configured to use parameters extracted from a service access request message to construct and send a token information request message and/or a create access token request message. A token information request message refers to a message that may be directed to the account management provider 304 requesting information about an access token, which may have been received by the service provider 302, such as in a service access request message. A create access token request message refers to a message that may be directed to the account management provider 304 requesting the creation and issuance of an access token, such as in exchange for a previously issued access token or in exchange for a request token. Accordingly, the client authentication unit 310 may further be configured to receive a token information message and an access token from the account management provider 304.

The client authentication unit 314 may further be configured to authenticate a received access token. In this regard, the client authentication unit 314 may be configured to verify that a received access token is associated with a user, client device 306, and/or service provider making a service access request and that the access token is still valid. Verifying the validity of an access token may include, for example, verifying that the access token has not expired, such as due to an expiration of a time limit or exhaustion of a granted number of uses. The client authentication unit 314 may be configured to perform this verification through any number of means, such as, for example, comparing parameters received in a service access request to those received in a token information message. The client authentication unit 314 may additionally or alternatively be configured to authenticate an access token by calculating security keys and/or hashes. These calculations may be based upon parameters received in a service access request and/or a token information message. Further, calculated values may be compared to parameters received in a service access request and/or token information message for authentication purposes. The client authentication unit 314 may further be configured to determine a level of user access based on the results of access token authentication. The client authentication unit 314 may accordingly be configured to communicate with the service user interface 312 so as to provide instructions indicating a level of user access to the requested service.

In some embodiments, the client authentication unit 314 may provide user authentication to users accessing a service provided by the service provider 302 via a web browser application executed on a client device 306 (also referred to as a “client web browser application”) in accordance with an appropriate authentication protocol. In some embodiments, the authentication protocol used may be in accordance with security assertion markup language (SAML) standards. However, embodiments of the invention are not limited to use of SAML and it will be appreciated that where use of SAML is discussed herein, another appropriate web protocol, language, or standard may be used. In this regard, the client authentication unit 314 may be configured to receive user logon (also referred to herein as “sign-in” or “sign-on”) information, such as, for example, via a web page interface and to redirect the web browser application to the account management provider 304 with an authentication request encoded as a parameter. The client authentication unit 314 may further be configured to receive a web browser application redirect from the account management provider 304, which may comprise a SAML artifact. In some embodiments, the client authentication unit 314 may be configured to send a message comprising the SAML artifact to the account management provider 304 requesting that the account management provider 304 resolve the artifact and in response to the request to receive a SAML assertion from the account management provider 304. The SAML assertion may comprise a client's account identification as known to the service provider 302 or indication thereof and a request token. The client authentication unit 314 may further be configured to instruct the service user interface 312 to provide the client's web browser application with the authenticated user's service home page in accordance with the user's access permissions as determined by the client authentication unit 314.

The memory 316 may include, for example, volatile and/or non-volatile memory. The memory 316 may be configured to store information, data, applications, instructions, or the like for enabling the apparatus to carry out various functions in accordance with exemplary embodiments of the present invention. For example, the memory 316 may be configured to buffer input data for processing by the processor 310. Additionally or alternatively, the memory 316 may be configured to store instructions for execution by the processor 316. As yet another alternative, the memory 316 may be one of a plurality of databases that store information in the form of static and/or dynamic information, for example, in association with mobile terminal context information, internet service context information, user status indicators, user activities, or the like. In this regard, the memory 316 may store, for example, received messages, parameters extracted from received messages, information about registered service users, and/or information about registered client devices 304. This stored information may be used by the service user interface 312 and/or client authentication unit 314 for performing their respective functionalities.

The communication interface 318 may be embodied as any device or means embodied in hardware, software, firmware, or a combination thereof that is configured to receive and/or transmit data from/to a network and/or any other device or module in communication with the service provider 302. The communication interface 318 may be embodied as or otherwise controlled by the processor 310. In this regard, the communication interface 318 may include, for example, an antenna, a transmitter, a receiver, a transceiver and/or supporting hardware or software for enabling communications with other entities of the system 300 via the communication links 308. Accordingly, via the communication interface 318 and communication links 308, the service provider 302 may communicate with the account management provider 304 and/or the client device 306. In this regard, the communication interface 318 may be in communication with the service user interface 312, client authentication unit 314, and memory 316. The communication interface 318 may be configured to communicate with remote devices of the system 300 using any networking protocol. In an exemplary embodiment, the communication interface 318 may be configured to communicate using hypertext transfer protocol (HTTP) security extensions such as Transport Layer Security (TLS) or Secure Sockets Layer (SSL). The communication interface 318 may further be configured to communicate and receive requests, data, and messages formatted according various web protocols such as hypertext markup language (HTML), extensible markup language (XML), and/or security extensions thereof, such as, for example, security assertion markup language (SAML).

Now referring to the account management provider 304 of FIG. 3, the account management provider 304 may serve as a repository of data about registered service users and may accordingly include a number of stored account identifications and passwords associated with registered service users, which may be stored, for example, in the memory 326. In this regard, the account management provider 304 may store data about a plurality of registered service users and each registered service user may be associated with a plurality of account identifications, such as user names, and password combinations, each combination associated with a different service. The account management provider may manage or otherwise communicate with a plurality of service providers 302 so as to provide for a single service sign-on and centralized user authentication manager. In an exemplary embodiment, the account management provider 304 may include a processor 320; means for determining a request type, means for extracting one or more parameters included in a request based upon a determined request type, means for performing one or more security checks, and means for creating an access token, such as a token creation unit 322; a token verification unit 324; memory 326; and means for receiving a request for an access token and means for providing an access token to a remote entity, such as a communication interface 328.

The processor 320 may be embodied in a number of different ways. For example, the processor 320 may be embodied as a microprocessor, a coprocessor, a controller, or various other processing means or elements including integrated circuits such as, for example, an ASIC (application specific integrated circuit) or FPGA (field programmable gate array). In an exemplary embodiment, the processor 320 may be configured to execute instructions stored in the memory 326 or otherwise accessible to the processor 320.

The token creation unit may be embodied as any device or means embodied in software, hardware, firmware, or any combination thereof and may be embodied as or otherwise controlled by the processor 320. The token creation unit 322 may be configured to create access tokens and/or request tokens, such as in response to a request for a token (referred to as a “create access token request message”). In this regard, the token creation unit 322 may be configured to receive a create access token request message, such as from a service provider 302 or client device 306. The token creation unit 322 may be configured to determine the type of the create access token request, such as based on parameters contained in the create access token request. Create access token request types may include, for example, a user identification and password combination, wherein an access token may be created based upon a received user identification and/or password; a request token exchange, wherein an access token may be created based upon a received request token; and an access token exchange, wherein an access token may be created based upon a received access token that may have been previously created and issued by the token creation unit 322. Accordingly, the token creation unit 322 may be configured to extract one or more parameters included in the create access token request message based upon the determined request type. These parameters may include, for example, one or more of a user identification, hash of a password, client key, client secret, a previously issued access token, and a request token.

The token creation unit 322 may be configured to use the extracted parameters to perform one or more security checks so as to authenticate a requesting user or client. For example, the token creation unit 322 may compare extracted parameters to user data stored in memory 326. In this regard, the token creation unit 322 may verify that an extracted user identification and password are known and correspond to each other. The token creation unit 322 may additionally or alternatively be configured to verify an association between a client identification, such as an identification of a requesting service provider 302 or client device 30, user identification, and a requested service. Additionally or alternatively, the token creation unit 322 may be configured to verify a signature contained in the create access token request message. Additionally or alternatively, the token creation unit 322 may be further configured to verify an association between an extracted request token, client key, client secret, and the requested service. Also additionally or alternatively, the token creation unit 322 may be configured to verify an association between an extracted previously issued access token, an associated token secret, client secret, and the requested service. Further, the token creation unit 322 may be configured to perform security checks based upon data stored in memory 326 which may indicate a predefined permissions level associated with a requesting user or client.

Based upon results of the performed security checks, the token creation unit 322 may be configured to create an access token having delimited service access rights, such as an extent of access to certain content or service provisions, usage rights or limitations, an expiration time, a number of allowable uses, a number of permissible users and/or indication of associated permissible user(s), an indication of one or more associated services with which the access token may be used, and/or other similar rights or restrictions based upon the user associated with the request, the requested service associated with the create access token request, and/or the requesting client device 306. In this regard, some requesting users or clients may be more “trusted” than others in that trusted users or trusted clients may have more service usage or access rights than a normal user or client. For example, if a photograph hosting service and a music hosting service are each acting as clients attempting to use a storage service, the photograph hosting service may be more trusted than the music hosting service and be accorded greater usage rights to the storage service, such as, for example, based on storage space required or otherwise requested by the respective requesting services or intellectual property rights concerns that may be raised by a music hosting service storing potentially infringing music files on the storage service.

The token creation unit 322 may be further configured to create a request token in response to receiving a request to resolve a SAML artifact. Additionally, the token creation unit 322 may be configured to provide a created access token or request token to the requesting service provider 302 or client device 306. Accordingly, the token creation unit 322 may, for example, send a created access token or request token to a requesting entity as a parameter in a message or otherwise provide means for the remote entity to access or download a created token stored on the account management provider 304, such as in memory 326.

The token verification unit 324 may be embodied as any device or means embodied in hardware, software, firmware, or a combination thereof and may be embodied as or controlled by the processor 320. The token verification unit 324 may be configured to receive a token information request message from a service provider 302. The token information request message may comprise an access token and in some embodiments, the token information request message may further comprise a service key and service secret associated with the service provider from which the token information request message was received. In some embodiments wherein the token information request message includes a service key and service secret, the service key and service secret may be included in a signature with which the token information request message is signed. The token verification unit 324 may accordingly be configured to verify an association between the access token, service key, and service secret. This verification may be based upon, for example, a database of issued access tokens or other access token data that may be stored in memory 326.

Additionally, the token verification unit 324 may be configured to determine one or more of a user identification, token secret, and client secret that are associated with the access token. The user identification, token secret, and client secret may be stored, for example, in association with an indication of the access token in memory 326. In this regard, the user identification determined by the token verification unit 324 is the user identification of the user or client known to the service provider 302 from which the token information request was received. This user identification may not be the same as the account identification by which the user or client is known to the account management provider 304 and may also be different from user identifications known to service providers other than the requesting service provider 302. Accordingly, the token verification unit 324 may be further configured to send a message comprising one or more of the determined user identification, client key, and token secret to the service provider 302 in response to the token information request message.

The memory 326 may include, for example, volatile and/or non-volatile memory. The memory 326 may be configured to store information, data, applications, instructions, or the like for enabling the apparatus to carry out various functions in accordance with exemplary embodiments of the present invention. For example, the memory 326 may be configured to buffer input data for processing by the processor 320. Additionally or alternatively, the memory 326 may be configured to store instructions for execution by the processor 326. In this regard, the memory 326 may store, for example, received messages, parameters extracted from received messages, information about registered account users, registered service providers, and/or information about registered client devices 304. This stored information may be used by the token creation unit 322 and/or token verification unit 324 for performing their respective functionalities.

The communication interface 328 may be embodied as any device or means embodied in hardware, software, firmware, or a combination thereof that is configured to receive and/or transmit data from/to a network and/or any other device or module in communication with the account management provider 304. The communication interface 328 may be embodied as or otherwise controlled by the processor 320. In this regard, the communication interface 328 may include, for example, an antenna, a transmitter, a receiver, a transceiver and/or supporting hardware or software for enabling communications with other entities of the system 300 via the communication links 308. Accordingly, via the communication interface 328 and communication links 308, the account management provider 304 may communicate with the service provider 302 and/or the client device 306. In this regard, the communication interface 328 may be in communication with the token creation unit 322, token verification unit 324, and memory 326. The communication interface 328 may be configured to communicate with remote devices of the system 300 using any networking protocol. In an exemplary embodiment, the communication interface 328 may be configured to communicate using hypertext transfer protocol (HTTP) security extensions such as Transport Layer Security (TLS) or Secure Sockets Layer (SSL). The communication interface 328 may further be configured to communicate and receive requests, data, and messages formatted according to various web protocols such as hypertext markup language (HTML), extensible markup language (XML), and/or security extensions thereof, such as, for example, security assertion markup language (SAML).

Referring now to the client device 306 of FIG. 3, the client device 306 may be any computing device from which a user may access or otherwise use a service provided by a service provider 302. In some embodiments, the client device 306 may be a mobile terminal 10 of FIG. 1. However, the client device 306 is not so limited in scope and may also be embodied as, for example, a desktop computing device, laptop computing device, and personal digital assistant. Moreover, it will be appreciated that although only a single client device 306 is illustrated in FIG. 3, a plurality of client devices 306 may be included in the system 300. In an exemplary embodiment, the client device 306 may include a processor 330, application user interface 332, communication interface 334, and memory 336.

The processor 330 may be embodied in a number of different ways. For example, the processor 330 may be embodied as a microprocessor, a coprocessor, a controller, or various other processing means or elements including integrated circuits such as, for example, an ASIC (application specific integrated circuit) or FPGA (field programmable gate array). In an exemplary embodiment, the processor 330 may be configured to execute instructions stored in the memory 336 or otherwise accessible to the processor 330. In embodiments wherein the client device 306 is a mobile terminal 10, the processor 330 may be embodied as the controller 20.

The application user interface 332 may be embodied as software, hardware, firmware, or a combination thereof and may be embodied as or controlled by the processor 330. The application user interface 332 may be embodied as or include any application that facilitates access to and/or use of a service provided by a service provider 302. In this regard, the application user interface 332 may be, for example a dedicated application such as a photograph client uploader, e-mail application, gaming application, multimedia player application, etc. Additionally, or alternatively the application user interface 332 may be embodied as or include a general purpose application such as a web browser application that enables access and/or use of a service provided by a service provider 302 over a network. The application user interface 332 may also be embodied as or include a web browser application plug-in, script, and/or application that may be deployed in a distributed manner over a network. The application user interface 332 may further be configured to receive an indication of a user input to the application user interface 332 such as through a keyboard, a mouse, a joystick, a touch screen display, a conventional display, a microphone, a speaker, or other input/output mechanisms. For example, the application user interface 332 may be configured to receive input of a request to use a service, interactions with a service, as well as sign-on information such as a user name and password. Additionally, the application user interface 332 may be configured to provide audio/visual output to a user of the client device 306. In this regard, the output may comprise data, services, content, messages, and/or requests received from the service provider 302 and the account management provider 304.

The communication interface 334 may be embodied as any device or means embodied in hardware, software, firmware, or a combination thereof that is configured to receive and/or transmit data from/to a network and/or any other device or module in communication with the client device 306. The communication interface 334 may be embodied as or otherwise controlled by the processor 330. In this regard, the communication interface 334 may include, for example, an antenna, a transmitter, a receiver, a transceiver and/or supporting hardware or software for enabling communications with other entities of the system 300 via the communication links 308. Accordingly, via the communication interface 334 and communication links 308, the client device 306 may communicate with the service provider 302 and/or the account management provider 304. In this regard, the communication interface 334 may be in communication with the application user interface 332 and memory 336. The communication interface 334 may be configured to communicate with remote devices of the system 300 using any networking protocol. In an exemplary embodiment, the communication interface 334 may be configured to communicate using hypertext transfer protocol (HTTP) security extensions such as Transport Layer Security (TLS) or Secure Sockets Layer (SSL). The communication interface 334 may further be configured to communicate and receive requests, data, and messages formatted according to various web protocols such as hypertext markup language (HTML), extensible markup language (XML), and/or security extensions thereof, such as, for example, security assertion markup language (SAML).

The memory 336 may include, for example, volatile and/or non-volatile memory (e.g. volatile memory 40 and non-volatile memory 42 in embodiments where the client device 306 is a mobile terminal 10). The memory 336 may be configured to store information, data, applications, instructions, or the like for enabling the apparatus to carry out various functions in accordance with exemplary embodiments of the present invention. For example, the memory 336 may be configured to buffer input data for processing by the processor 330. Additionally or alternatively, the memory 336 may be configured to store instructions for execution by the processor 336. In this regard, the memory 336 may store, for example, user account information, such as a user identification and any associated password used for the account management provider 304 and/or a plurality of service providers 302. In some embodiments, some or all of this account management information may be stored in the form of cookies that may be accessed and used by a web browser application included in the application user interface 332. The memory may further store access tokens that may be received from the account management provider 304. This stored information may be used by the application user interface 332.

Referring now to FIG. 4, a more specific embodiment of a system 300 is illustrated. The system of FIG. 4 includes a client web browser application 400, a photo service 402, account management provider 304, storage service 406, and photo client application 408 which are interconnected via the illustrated network. In this regard, the photo service 402 and storage service 406 represent specific embodiments of a service provider 302 which provide photograph hosting and access services and file storage service, respectively. The client web browser application 400 and photo client application 408 are exemplary embodiments of an application user interface 332 and may be embodied in either the same client device 306 or in separate client devices 306. An example use case scenario will now be described in reference to the system of FIG. 4 as well as entities of the system 300. This use case scenario is provided merely for purposes of example and should not be construed to limit the invention in any manner with regard to entities, services, communication protocols, or order of operations as described in the use case scenario.

A user using the photo client application 408 may wish to access a photo album at the photo service 402. The photo client application 408 may need an access token in order to access the photo service 402 and may obtain the access token from the account management provider 304. The photo client application 408 may thus construct a create access token request message. This message may be formatted in XML and may comprise a user identification and password of the user as known to the account management provider 304. The photo client application 408 may retrieve the user identification and password from memory, such as memory 336, or may prompt the user to enter a user identification and password. The photo client application may then sign the create access token request message using its client key and client secret. The key and signature may be conveyed in an HTTP header. The create access token request message may then be sent to the account management provider 304 over a TLS HTTP connection (https).

The token creation unit 322 of the account management provider 304 may then determine that the request type of the received create access token request message is a user identification and password combination and extract the user identification, password, client key, and client secret from the create access token request message. The token creation unit 322 may then verify the user identification and password as well as the client key; signature of the create access token request message; and the associations between the client identification, user identification, and the photo service during the course of performing security checks based upon the extracted parameters. Assuming the token creation unit 322 properly verifies the create access token request message, the token creation unit 322 may create an access token and associate it with an authentication session for the requesting user, with the photo service 402, and with a token secret. The token creation unit 322 may then send the photo client application 408 a message including the access token and the token secret. The photo client application 408 may now use the received access token to access the photo service 402.

In response to a request from the user, the photo client application 408 may then construct a message to upload a photo to the photo service 402. The interface and communications protocol used by the photo client application 408 to interact with the photo service 402 may be in accordance with any interface and communications protocol which the photo service 402 and photo client application 408 are configured to use and accordingly are not limited in any way by embodiments of this invention. However, in general, the photo client application 408 may, for example, construct a message including the access token, one or more photo files, a photo album identifier, and any associated data such as a caption associated with a photo file. The photo client application 408 may sign the message with a concatenation of its client secret and the token secret and may place the signature, access token, and client key in the message header. In this regard, the access token may be used both as a token in the message body and as part of a sender key to sign the message. Thus the access token may be used to overcome security vulnerabilities associated with the client application key as while the long-lived client key and client secret may be hacked from a client device 306, the token key and token secret are randomly generated and issued by the account management provider 304 and are relatively short-lived. The photo client application may then send the photo upload message to the photo service 402, such as by using HTTP.

The photo service 402 may then receive the photo upload message from the photo client application and retrieve the access token included in the message. At this point, the photo service 402 may not know with what user of the photo service the access token is associated and thus may construct a token information request message and send it to the account management provider 304. The photo service 402 may sign the message with its own service key and service secret. The message may be sent in accordance with TLS. Upon receipt of the token information request message, the account management provider 304 may perform a number of verification steps, such as verifying an association between the access token, service key, and service secret included in the token information request message. The token verification unit 324 of the account management provider 304 may then determine a user identification as known to the photo service 402 that is associated with the access token, the token secret, and the client key that was used to obtain the access token and construct a token information message including the user identification, token secret, and client key and send the token information message to the photo service 402.

Upon receipt of the token information message, the client authentication unit 314 of the photo service 402 may extract the parameters included in the token information message and verify that the client key received in the token information message matches the client key received in the photo upload message from the photo client application 408. The photo service 402 may then verify the signature on the photo upload message and may also verify that the user with whom the access token is associated still has access permission to upload photos. The photo service 402 may use the storage service 406 for storage of uploaded photos. In order for the photo service 402 to invoke the storage service 406, the photo service 402 needs an appropriate access token. Accordingly, the photo service 402 may construct a create access token request message comprising the access token received from the photo client application 408 and an indication of the storage service 406, such as for example, the DNS name of the storage service 406. The photo service 402 may sign the create access token request message with the service secret and access token secret and send the create access token request message to the account management provider. The message may be sent, for example, according to TLS protocol.

Upon receipt of the create access token request message, the token creation unit 322 of the account management provider 304 may then determine that the request type is an access token exchange and extract the previously issued access token, service secret, and token secret from the message. The token creation unit 322 may then verify an association between the access token, token secret, and service secret. The token creation unit 322 may further verify that the user or client with which the received access token is associated and/or the photo service 402 have permission to access the storage service 406. Assuming the token creation unit 322 properly verifies the create access token request message and permission to access the storage service 406, as before, the token creation unit 322 may create an access token and associate it with an authentication session for the requesting user, with the storage service 406, and with a token secret. The token creation unit 322 may then send the photo service 402 a message including the newly created access token and the token secret.

Upon receipt of the message from the account management provider 304 of the message containing the newly created access token, the photo service 402 may create a save file message comprising the new access token and the photo file. The photo service 402 may sign the save file message with a concatenation of its own service secret and the new token secret. The photo service 402 may, for example, place its service key, the new access token, and the signature in an HTTP Authorize header and send the save file message to the storage service 406. The client authentication unit 314 of the storage service 406 may then parse the access token out of the received save file message and construct a token information request message comprising the parsed access token. The client authentication unit 314 of the storage service 406 may then sign the token information request message with the storage service key and storage service secret and send the token information request message to the account management provider 304 using, for example, TLS.

Upon receipt of the token information request message, the account management provider 304 may, as before, perform a number of verification steps, such as verifying an association between the access token, service key, and service secret included in the token information request message. The token verification unit 324 of the account management provider 304 may then determine a user identification as known to the storage service 406 that is associated with the access token, the token secret, and the photo service key (note in this situation where one service provider is invoking a second service provider, the first service provider, e.g. the photo service, is acting as a client and in essence the photo service key is equivalent to a client key) that was used to obtain the access token and construct a token information message including the user identification, token secret, and photo service key and send the token information message to the storage service 406.

The client authentication unit 314 of the storage service 406 may then verify the photo service key included in the save file message by comparing it to the photo service key received in the token information message from the account management provider 304. The client authentication unit 314 of the storage service 406 may additionally verify the signature on the save file message using the token secret and photo service secret. If the storage service appropriately verifies the save file message, then the storage service 406 may use the user identification to determine in which account storage space to store the photograph data included in the save file message.

Some time later, the user may wish to organize his online photograph album and thus may browse to a web user interface of the photo service 402, such as may be provided by the service user interface 312 of the photo service 402, using the client web browser application 400. The service user interface 312 of the photo service 402 may provide the client web browser application 400 with a login form if there is no existing session for the user, such as in a situation where the client web browser application 400 is embodied on a different client device from the photo client application 408 or where a previous login session has expired. The user may then enter appropriate login information and the client authentication unit 314 of the photo service 402 may redirect the client web browser application 400 to an authentication request endpoint of the account management provider 304 with the authentication request encoded as a URL parameter. The account management provider 304 may then verify the user login information and redirect the client web browser application to the photo service 402 with a SAML artifact as a parameter. The client authentication unit 314 may then send a message to the account management provider 304 requesting that the SAML artifact be resolved. The account management provider 304 may then respond with a SAML assertion comprised of the user's account identification as known to the photo service 402 and a request token. The service user interface 312 of the photo service 402 may now provide the client web browser application 400 with the user's home page, which may, for example, contain links to the user's photograph albums.

The user may then click a link to access one of his photograph albums. The photo service 402 may now need to retrieve several photograph files from the storage service 402. The photo service 402 thus needs an access token and constructs a create access token request message comprising the request token received in the SAML assertion and an indication of the storage service 406, such as for example, the DNS name of the storage service 406. The photo service 402 may sign the create access token request message with the photo service key and photo service secret and send the message over TLS to the account management provider 304.

The token creation unit 322 of the account management provider 304 may then determine that the request type of the create access token request message is a request token exchange and extract the request token, photo service key (equivalent to a client key for purposes of invoking the storage service), and the photo service secret (equivalent to a client secret for purposes of invoking the storage service). The token creation unit 322 may then verify the signature of the create access token request message and verify an association between the request token photo service key, and photo service secret based upon the extracted parameters. Assuming the token creation unit 322 properly verifies the create access token request message, the token creation unit 322 may create an access token and associate it with an authentication session for the requesting user, with the storage service 406, and with a token secret. The token creation unit 322 may then send the photo service 402 a message including the access token and the token secret.

The photo service 402 may then construct a get file message comprising the received access token, requested file name(s), and photo service key. The photo service 402 may sign the get file message with its photo service secret and token secret and send the message to the storage service 406. As before, the storage service 406 may extract parameters from the message and construct a token information request message and send the token information request message to the account management provider 304. Again, as before, the account management provider 304 may verify the access token and respond to the storage service 406 with a token information message. The storage service 406 may use parameters contained in the token information message as before to verify the get file message and to determine how to appropriately access the user files using the user identification received in the token information message.

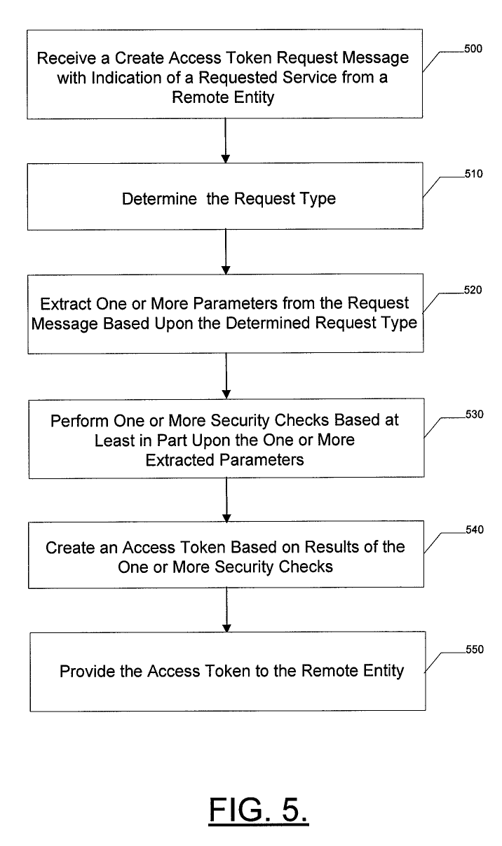

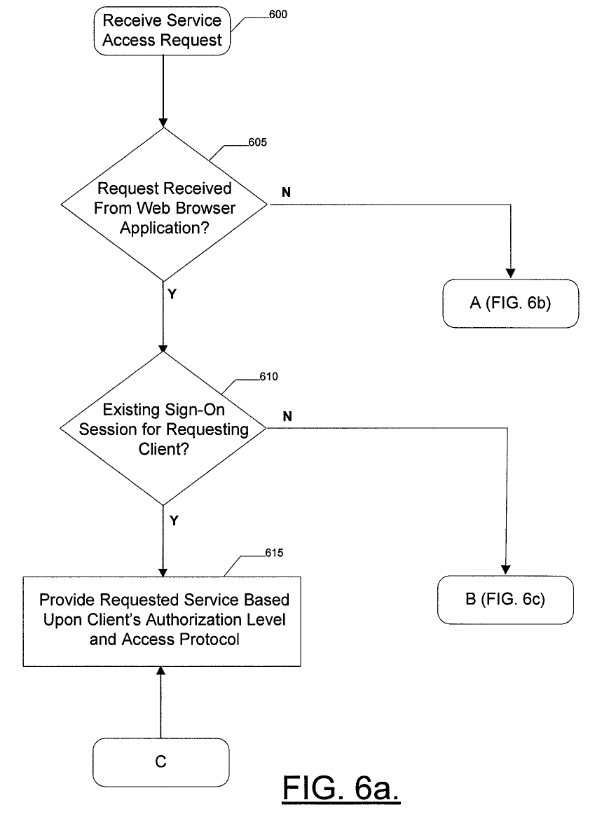

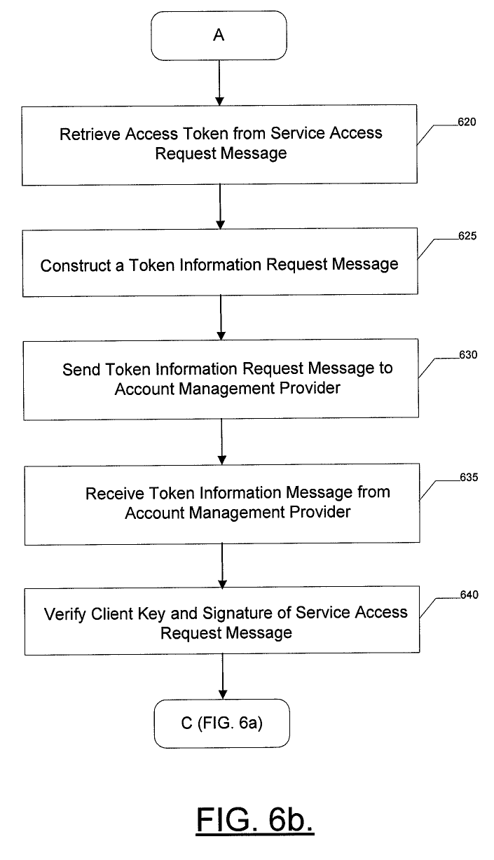

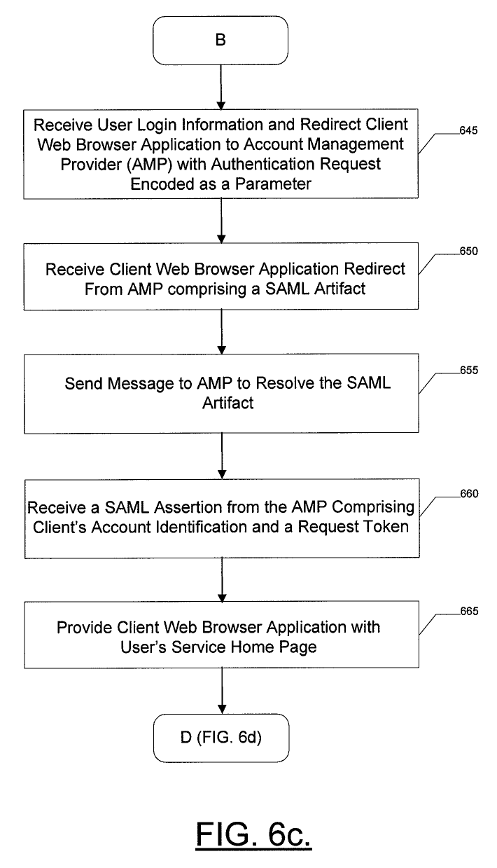

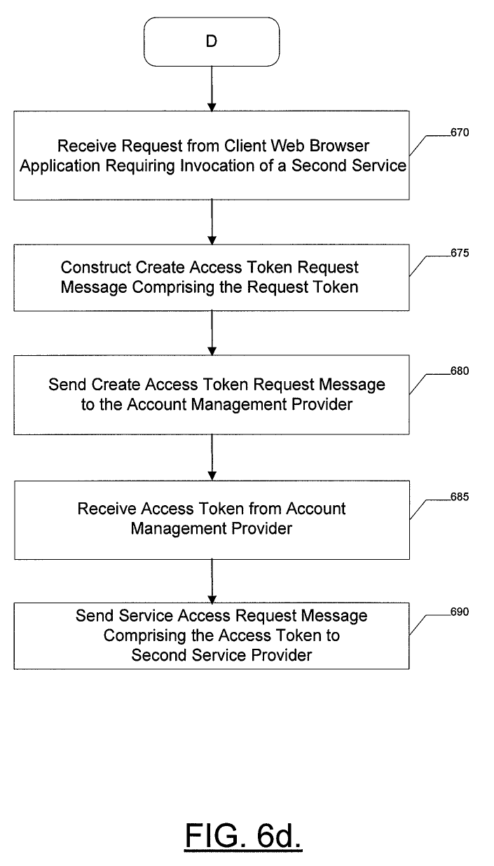

FIGS. 5 and 6 are flowcharts of a system, method, and computer program product according to an exemplary embodiment of the invention. It will be understood that each block or step of the flowcharts, and combinations of blocks in the flowcharts, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal, server, or other computing device and executed by a built-in processor in the computing device. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowchart, may be implemented by special purpose hardware-based computer systems which perform the specified functions or steps, or combinations of special purpose hardware and computer instructions.

In this regard, one exemplary method for providing a single service sign-on from the perspective of an account management provider according to an exemplary embodiment of the present invention is illustrated in FIG. 5. The method may include receiving a create access token request message with an indication of a requested service from a remote entity at operation 500. Operation 510 may comprise the account management provider determining the request type. In this regard, the request type may be a user identification and password combination, a request token exchange, or an access token exchange. The account management provider may then extract one or more parameters from the create access token request message based upon the determined request type at operation 520. Operation 530 may comprise the account management provider performing one or more security checks based at least in part upon the one or more extracted parameters. The account management provider may then create an access token based on results of the one or more security checks at operation 540. Operation 550 may comprise the account management provider providing the access token to the requesting remote entity.

FIG. 6 illustrates an exemplary method for providing a single service sign-on from the perspective of a service provider according to an exemplary embodiment of the present invention. Referring first to FIG. 6a, Operation 600 may comprise receiving a service access request, such as from a user device or from another service provider. Operation 605 may comprise determining whether the service access request was received from a web browser application. If the request was not received from a web browser application, then the method may proceed to Operation 620 on FIG. 6b. Operation 620 may comprise retrieving an access token from the service access request message. The service provider may then construct a token information request message at operation 625 and send the token information request message to an account management provider at operation 630. Operation 635 may comprise the service provider receiving a token information message from an account management provider. The service provider may then verify the client key and signature of the service access request message based on information obtained in the token information message at operation 640. If the service provider properly verifies the service access request message, then the method may proceed to operation 615 on FIG. 6a, wherein the service provider may provide the requested service based upon the requesting client's authorization level and access protocol capabilities.

Referring again to FIG. 6a, if at operation 605 the service provider determines that the service access request message was received from a web browser application, then at operation 610 the service provider may determine whether there is an existing sign-on session for the requesting client. If there is an existing sign-on session then the service provider may provide the requested service based upon the client's authorization level and access protocol capabilities at operation 615. If there is not an existing sign-on session, then the method may proceed to operation 645 on FIG. 6c. In this regard, Operation 645 may comprise receiving user login information and redirecting the client web browser application to an account management provider with an authentication request encoded as a parameter. The service provider may then receive a client web browser application redirect from the account management provider, wherein a SAML artifact is included in the redirect at operation 650. Operation 655 may comprise the service provider sending a message to the account management provider requesting that the account management provider resolve the SAML artifact. The service provider may then receive a SAML assertion from the account management provider comprising the requesting client's account identification and a request token at operation 660. The service provider may then provide the client web browser application with the user's service home page at operation 665.

Referring now to FIG. 6d, during the course of a user's interaction with the service, the service provider may receive a request from the client web browser application requiring invocation of a second service at operation 670. The service provider may then construct a create access token request message comprising the request token at operation 675 and send the create access token request message to the account management provider at operation 680. The service provider may then receive an access token from the account management provider at operation 685 and subsequently send a service access request message comprising the access token to a second service provider at operation 690. The second service provider may then proceed from operation 600 of FIG. 6a as has previously been described with the first service provider being the requesting client.

The above described functions may be carried out in many ways. For example, any suitable means for carrying out each of the functions described above may be employed to carry out embodiments of the invention. In one embodiment, all or a portion of the elements generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention may provide several advantages to a user of a computing device, such as a mobile terminal 10. For example, a user of a user device may be provided with a single service sign-on allowing the user to use a variety of services while only being requested to sign-on to a single service. In this regard, an account management provider may manage and facilitate interactions between a user and a multitude of services. Embodiments of the invention may further provide benefits to service providers as common application libraries and interfaces may be used for authentication purposes as authentication for multiple service providers may be handled by a centralized account management provider. Further, embodiment of the invention may provide a single service sign-on that is device and application independent as the account management provider may receive and respond to requests received in several different protocols and to associate all of the sign-ons with the requesting user so that a sign-on session may be maintained or correlated for a user even if the user uses another application or computing device to make a subsequent service request. Additionally, embodiments of the invention may provide enhanced security so as to protect data and content provided by service providers as well as user accounts through the use of short-lived access tokens.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving a request for an access token from a remote entity, wherein the request includes an indication of a requested service;
determining a request type, wherein the request type may be a user identification and password combination, a request token exchange, or an access token exchange;
extracting one or more parameters included in the request based upon the determined request type;
performing one or more security checks based at least in part upon the one or more extracted parameters;
creating an access token based at least in part upon results of the one or more security checks; and
providing the access token to the remote entity.

2. A method according to claim 1, wherein extracting one or more parameters included in the request based upon the determined request type comprises:
extracting a user identification, hash of a password, and a signature comprising a client key and client secret if the determined request type is a user identification and password combination;
extracting a request token and a signature comprising a client key and a client secret if the determined request type is a request token exchange; or
extracting a previously issued access token and a signature comprising a client secret and a token secret if the determined request type is an access token exchange.

3. A method according to claim 2, wherein performing one or more security checks based at least in part upon the one or more extracted parameters comprises:
verifying that the user identification and hash of the password are known and correspond to each other; verifying the signature; and verifying an association between client identification, user identification, and the requested service if the determined request type is a user identification and password combination;
verifying the signature and verifying an association between the request token, client key, and client secret if the determined request type is a request token exchange; or
verifying the signature and verifying an association between the previously issued access token, token secret, and client secret if the determined request type is an access token exchange.

4. A method according to claim 1, wherein performing one or more security checks based at least in part upon the one or more extracted parameters further comprises verifying that the remote entity has authorization to access the requested service.

5. A method according to claim 1, wherein creating an access token based at least in part upon results of the one or more security checks comprises creating an access token associated with a user and the requested service and creating a token secret associated with the access token.

6. A method according to claim 1, wherein creating an access token based at least in part upon results of the one or more security checks comprises creating an access token having defined access permissions, wherein the defined access permissions include one or more of one or more associated services which the access token may be used to access, one or more associated users, a use period for which the access token is valid, and a number of uses for which the access token is valid.

7. A method according to claim 1, wherein the remote entity is one of a client device or a service provider.

8. A method according to claim 1, further comprising:
receiving a token information request message from a service provider, wherein the token information message comprises an access token, and wherein the token information message is signed with a service key and a service secret;
verifying an association between the access token, the service key, and the service secret;
determining a user identification, token secret, and client secret that are associated with the access token; and
sending a message comprising the determined user identification, client key, and token secret to the service.

9. A computer program product comprising at least one computer-readable storage medium having computer-readable program code portions stored therein, the computer-readable program code portions comprising:
a first program code portion for receiving a request for an access token from a remote entity, wherein the request includes an indication of a requested service;
a second program code portion for determining a request type, wherein the request type may be a user identification and password combination, a request token exchange, or an access token exchange;
a third program code portion for extracting one or more parameters included in the request based upon the determined request type;
a fourth program code portion for performing one or more security checks based at least in part upon the one or more extracted parameters;
a fifth program code portion for creating an access token based at least in part upon results of the one or more security checks; and
a sixth program code portion for providing the access token to the remote entity.

10. A computer program product according to claim 9, wherein the third program code portion includes instructions for:
extracting a user identification, hash of a password, and a signature comprising a client key and client secret if the determined request type is a user identification and password combination;
extracting a request token and a signature comprising a client key and a client secret if the determined request type is a request token exchange; or
extracting a previously issued access token and a signature comprising a client secret and a token secret if the determined request type is an access token exchange.

11. A computer program product according to claim 10, wherein the fourth program code portion includes instructions for:
verifying that the user identification and hash of the password are known and correspond to each other; verifying the signature; and verifying an association between client identification, user identification, and the requested service if the determined request type is a user identification and password combination;
verifying the signature and verifying an association between the request token, client key, and client secret if the determined request type is a request token exchange; or
verifying the signature and verifying an association between the previously issued access token, token secret, and client secret if the determined request type is an access token exchange.

12. A computer program product according to claim 9, wherein the fourth program code portion includes instructions for verifying that the remote entity has authorization to access the requested service.

13. A computer program product according to claim 9, wherein the fifth program code portion includes instructions for creating an access token associated with a user and the requested service and creating a token secret associated with the access token.

14. A computer program product according to claim 9, wherein the fifth program code portion includes instructions for creating an access token having defined access permissions, wherein the defined access permissions include one or more of one or more associated services which the access token may be used to access, one or more associated users, a use period for which the access token is valid, and a number of uses for which the access token is valid.

15. A computer program product according to claim 9, wherein the remote entity is one of a client device or a service provider.

16. A computer program product according to claim 9, further comprising:
a seventh program code portion for receiving a token information request message from a service provider, wherein the token information message comprises an access token, and wherein the token information message is signed with a service key and a service secret;
an eighth program code portion for verifying an association between the access token, the service key, and the service secret;
a ninth program code portion for determining a user identification, token secret, and client secret that are associated with the access token; and
a tenth program code portion for sending a message comprising the determined user identification, client key, and token secret to the service.

17. An apparatus comprising a processor configured to:
receive a request for an access token from a remote entity, wherein the request includes an indication of a requested service;
determine a request type, wherein the request type may be a user identification and password combination, a request token exchange, or an access token exchange;
extract one or more parameters included in the request based upon the determined request type;
perform one or more security checks based at least in part upon the one or more extracted parameters;
create an access token based at least in part upon results of the one or more security checks; and
provide the access token to the remote entity.

18. An apparatus according to claim 17, wherein the processor is further configured to extract one or more parameters included in the request based upon the determined request type by:
extracting a user identification, hash of a password, and a signature comprising a client key and client secret if the determined request type is a user identification and password combination;
extracting a request token and a signature comprising a client key and a client secret if the determined request type is a request token exchange; or
extracting a previously issued access token and a signature comprising a client secret and a token secret if the determined request type is an access token exchange.

19. An apparatus according to claim 18, wherein the processor is further configured to perform one or more security checks based at least in part upon the one or more extracted parameters by:
verifying that the user identification and hash of the password are known and correspond to each other; verifying the signature; and verifying an association between client identification, user identification, and the requested service if the determined request type is a user identification and password combination;
verifying the signature and verifying an association between the request token, client key, and client secret if the determined request type is a request token exchange; or
verifying the signature and verifying an association between the previously issued access token, token secret, and client secret if the determined request type is an access token exchange.

20. An apparatus according to claim 17, wherein the processor is further configured to perform one or more security checks based at least in part upon the one or more extracted parameters by verifying that the remote entity has authorization to access the requested service.

21. An apparatus according to claim 17, wherein the processor is further configured to create an access token associated with a user and the requested service and to create a token secret associated with the access token.

22. An apparatus according to claim 17, wherein the processor is further configured to create an access token having defined access permissions, wherein the defined access permissions include one or more of one or more associated services which the access token may be used to access, one or more associated users, a use period for which the access token is valid, and a number of uses for which the access token is valid.

23. An apparatus according to claim 17, wherein the remote entity is one of a client device or a service provider.

24. An apparatus according to claim 23 wherein the processor is further configured to:
receive a token information request message from a service provider, wherein the token information message comprises an access token, and wherein the token information message is signed with a service key and a service secret;
verify an association between the access token, the service key, and the service secret;
determine a user identification, token secret, and client secret that are associated with the access token; and
send a message comprising the determined user identification, client key, and token secret to the service.

25. An apparatus comprising:
means for receiving a request for an access token from a remote entity, wherein the request includes an indication of a requested service;
means for determining a request type, wherein the request type may be a user identification and password combination, a request token exchange, or an access token exchange;
means for extracting one or more parameters included in the request based upon the determined request type;
means for performing one or more security checks based at least in part upon the one or more extracted parameters;
means for creating an access token based at least in part upon results of the one or more security checks; and
means for providing the access token to the remote entity.
